(19) United States
(12) Patent Application Publication
(10) Pub. No.: US 2005/0014120 A1
(43) Pub. Date: Jan. 20, 2005

(54) A Method to Measure the Learning Retention of Students Engaged in a Course of Self-Study

(76) Inventor: Tim Hatton, Dayton, OH (US)

Correspondence Address: Tim Hatton, 4802 Bordeaux Lane, Mason, OH, 45040, US

(21) Appl. No.: 10/604,069

(22) Filed: Jun. 25, 2003

(51) Int. Cl. G09B 3/00

(52) U.S. Cl. 434/350

(57) ABSTRACT

A method to eliminate the inefficiencies of the self-study process by providing a method of validation of the level of subject matter knowledge gained from a course of such study.

### BRIEF SUMMARY OF THE INVENTION

A common problem faced by students engaged in a course of self-study is how to validate the learning experience or to gain actual work experience in the subject matter under study. Such students learn by reading commercial books and publications or by taking online courses. Such methods do not allow the student to directly validate the learning experience by performing real world tasks and having those tasks evaluated by a qualified instructor.

The instant invention addresses that shortcoming by providing a mechanism whereby students can receive such validation and support in an online environment. Upon completion of a course of self-study, the student is given a work assignment to accomplish. The student works alone to complete the assignment and has access to an instructor through online interaction for assistance during this phase of the project. Upon completion of the project, the student submits the project for evaluation and critique by the instructor.

The primary value to both students engaged in a course of self-study and employers who are paying for such study is economic in that the invention allows a measurement of the student's level of knowledge of the subject matter and provides feedback for where remedial learning may take place. This shortens the overall learning curve and reduces the total expenditure that may be required to reach a measurable level of accomplishment.

The instant invention comprises the process of the student accessing the validation software, signing up for the project, downloading and viewing the project specifications, transmitting the completed project for evaluation and the evaluation process.

### DETAILED DESCRIPTION OF THE INVENTION

The knowledge validation process begins when the student completes his initial course of self-study. At that time, the student visits an online area where he is presented with a choice of projects for which he may sign up to be validated. The student chooses the project most appropriate to his course of study and is directed to the signup area for that project.

In the signup area, the student enters payment information for the project. Payment information may be by credit card, EFT, E-Check or by providing a valid corporate contract identification number if the student's employer has entered into an arrangement purchasing a site license. Once the payment has been validated, the student is directed to the main project page.

On the main project page, the student is presented with the ability to view or download the project specifications. These specifications detail a project which, as it is being completed, will allow an objective assessment of the student's mastery of the subject matter. The student works on his own initiative to complete the project and may visit an online forum to discuss the project with other students (past and present) or to ask questions from a subject matter expert.

Upon completion of the project, the student again visits an online area where he uploads his project for evaluation. This transmits the project to a subject matter expert for review. The subject matter expert reviews the project and measures it against objective criteria for project of that type and complexity utilizing the target technology. He completes a standard evaluation form detailing areas in which the student shows a mastery of the subject matter and areas in which the student could improve his knowledge, together with suggestion as to how to proceed to make that improvement.

The marked up project and the evaluation are returned to the student by electronic transmission. Should the student wish to alter his project, he may do so and may return to the upload area for another evaluation.

At the end of the process, the student has improved his grasp of the subject matter covered by his course of self-study and has an objective, third party assessment of his level of expertise in that subject matter.

1. A method of providing a measurement of the level of knowledge a student has gained from a course of self-study:

2. A method according to claim number one whereby the student visits an online area and selects a project that matches the subject matter of his course of self-study.

3. A method according to claim number one whereby the student views and/or downloads the specifications for a project designed to mearure his level of knowledge in a particular subject matter.

4. A method according to claim number one whereby the student interacts with other students and a subject matter expert with respect to issues that may arise during the completion of his project.

5. A method according to claim number one whereby the students electronically transmits his completed project to a subject matter expert for review and evaluation.

6. A method according to claim number one whereby the subject matter expert evaluates the submitted project and applies objective criteria to measure the student's mastery of the subject matter.

7. A method according to claim number one whereby the subject matter expert returns the evaluated project to the student for further action.
